(19) United States
(12) Patent Application Publication
(10) Pub. No.: US 2016/0349422 A1
(43) Pub. Date: Dec. 1, 2016

(54) OPTICAL FILM, DISPLAY PANEL, AND DISPLAY DEVICE

(71) Applicant: Panasonic Intellectual Property Management Co., Ltd., Osaka (JP)

(72) Inventors: Kazuhiro YAMADA, Osaka (JP); Takashi YAMADA, Osaka (JP)

(21) Appl. No.: 15/234,568

(22) Filed: Aug. 11, 2016

Related U.S. Application Data
(63) Continuation of application No. PCT/JP2015/000003, filed on Jan. 5, 2015.

(30) Foreign Application Priority Data
Mar. 20, 2014 (JP) 2014-057467

(51) Int. Cl. G02B 5/22; G06F 3/038; G06F 3/03; G02B 5/08; G06F 3/0354

(52) U.S. Cl. CPC G02B 5/22; G02B 5/08; G06F 3/03542; G06F 3/0321; G06F 3/038

(57) ABSTRACT

The present disclosure is intended to increase color variations in a bezel portion while maintaining accuracy of reading a position information pattern of the bezel portion using a reader. An optical film of the present disclosure includes a display portion and a bezel portion formed around the display portion. The display portion and the bezel portion each are provided with a pattern representing position information of each of a plurality of unit areas. A back side of the bezel portion is provided with a first bezel decorative layer that absorbs a specific visible wavelength and transmits infrared wavelengths of incident light and a second bezel decorative layer that reflects infrared wavelengths of light passing through the first bezel decorative layer.

### BACKGROUND

1. Technical Field

The present disclosure relates to an optical film, a display panel, and a display device.

2. Description of Related Art

A technique has been known that reads a position information pattern representing a coordinate position on the plane of a display device using a pen-type device, for example, as disclosed in Unexamined Japanese Patent Publication No. 2012-243201.

### SUMMARY

A screen of a display device includes a display portion for displaying images and the like and a bezel portion surrounding a display portion. Here, it is required that color variations in the bezel portion are increased as well as accuracy of reading a position information pattern of the bezel portion using a reader is maintained.

The present disclosure is directed to increase the color variations in the bezel portion while maintaining the accuracy of reading the position information pattern of the bezel portion using a reader.

An optical film of the present disclosure includes a display portion and a bezel portion formed around the display portion. The display portion and the bezel portion each are provided with a pattern representing position information of each of a plurality of unit areas. A back side of the bezel portion is provided with a first bezel decorative layer that absorbs a specific visible wavelength and transmits infrared wavelengths of incident light and a second bezel decorative layer that reflects infrared wavelengths passing through the first bezel decorative layer.

The present disclosure can increase the color variations in the bezel portion while maintaining the accuracy of reading the position information pattern of the bezel portion using a reader.

### BRIEF DESCRIPTION OF DRAWINGS

FIG. 1 is an external view of a display control system according to a first exemplary embodiment.

FIG. 2 is a block diagram of the display control system according to the first exemplary embodiment.

FIG. 3 is a cross-sectional view taken along line 3-3 of a display panel of FIG. 1.

FIG. 4 is an enlarged view of a dot pattern according to the first exemplary embodiment.

FIG. 5A is a first diagram illustrating a positioning pattern of a dot according to the first exemplary embodiment.

FIG. 5B is a second diagram illustrating a positioning pattern of a dot according to the first exemplary embodiment.

FIG. 5C is a third diagram illustrating a positioning pattern of a dot according to the first exemplary embodiment.

FIG. 5D is a fourth diagram illustrating a positioning pattern of a dot according to the first exemplary embodiment.

FIG. 6 is a diagram illustrating a dot pattern and a unit area according to the first exemplary embodiment.

FIG. 7 is a flow chart illustrating an operation of a digital pen according to the first exemplary embodiment.

FIG. 8 is a flow chart illustrating an operation of a display device according to the first exemplary embodiment.

FIG. 9 is another cross-sectional view taken along line 3-3 of a display panel of FIG. 1.

FIG. 10 is still another cross-sectional view taken along line 3-3 of a display panel of FIG. 1.

### DETAILED DESCRIPTION

Exemplary embodiments will now be described in detail with reference to the drawings. Unnecessary details, however, may be omitted. For example, detailed description of well-known matters and repeated description of substantially the same configuration may be omitted. This is to avoid unnecessary redundancy in the following description and to facilitate understanding by those skilled in the art.

The accompanying drawings and the following description are provided to enable those skilled in the art to have a thorough understanding of the present disclosure, and these are not intended to limit the subject matter defined by the claims.

### First Exemplary Embodiment

### [1. Configuration of Display Control System]

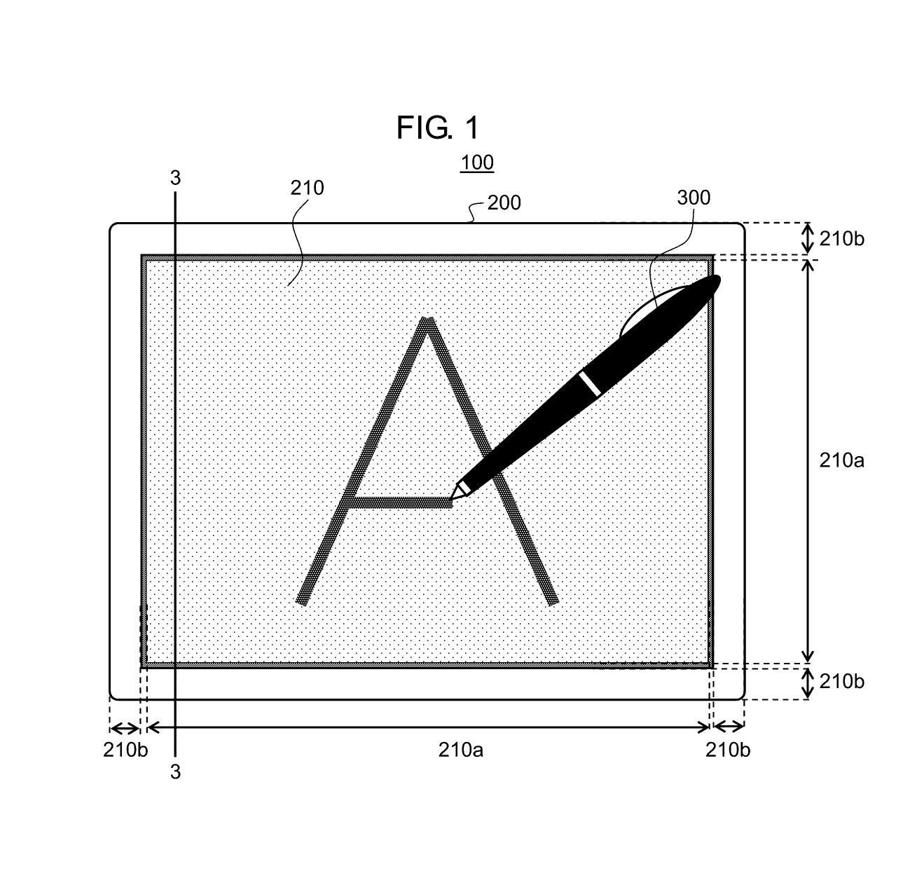

FIG. 1 is an external view of display control system 100 according to a first exemplary embodiment. Display control system 100 includes display device 200 and optical digital pen (hereinafter “digital pen”) 300. Display device 200 includes display panel 210. A surface of display panel 210 is divided into display portion 210a for displaying images and the like and bezel portion 210b surrounding display portion 210a. In FIG. 1, a boundary between display portion 210a and bezel portion 210b is provided with a gap having a predetermined distance.

The boundary between display portion 210a and bezel portion 210b may be provided with no gap.

Display portion 210a and bezel portion 210b of display panel 210 are provided with a dot pattern representing information about a position on display panel 210. Digital pen 300 optically reads the dot pattern with its tip to detect information about a position (hereinafter “position information”) on display panel 210 at which the tip of digital pen 300 is located. Display device 200 and digital pen 300 are connected by wireless communication, and digital pen 300 sends the detected position information to display device 200. In this manner, display device 200 determines the position information of the tip of digital pen 300 and performs various types of display control.

The display control, for example, when the tip of digital pen 300 is moved on display panel 210 is described. In this case, digital pen 300 detects continuous position information on a locus of the tip of digital pen 300 based on dot patterns that digital pen 300 has sequentially read. Digital pen 300 sequentially sends the detected position information to display device 200. Thus, display device 200 can sequentially display, on display panel 210, dots following the locus of the tip of digital pen 300. This function allows a user to input characters, drawings, etc. on display panel 210 by handwriting with digital pen 300.

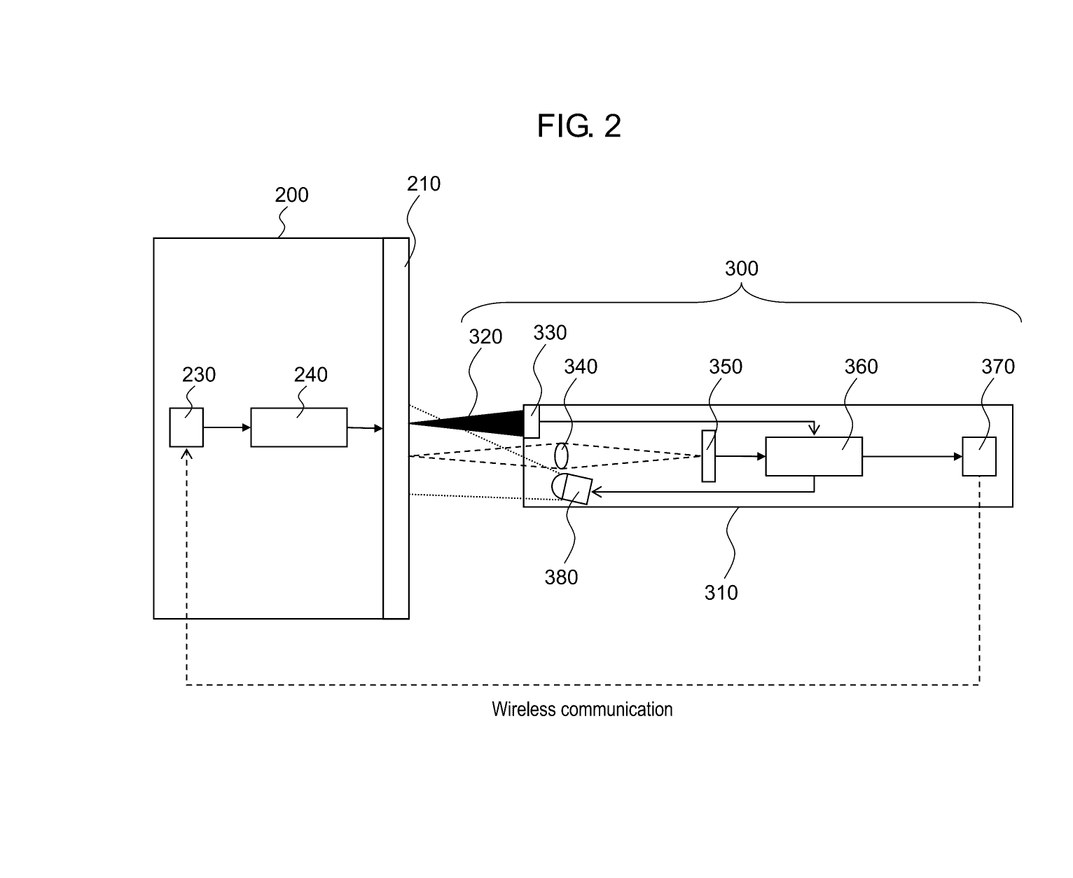

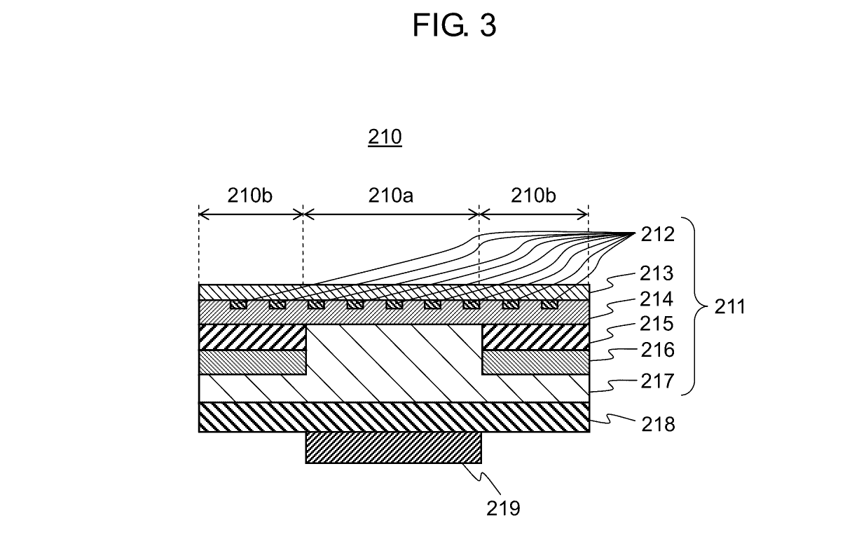

A configuration of display control system 100 is then described. FIG. 2 is a block diagram of display control system 100 according to the first exemplary embodiment, and FIG. 3 is a cross-sectional view taken along 3-3 of display panel 210 of FIG. 1.

In FIG. 2, display device 200 includes display panel 210, receiver 230, and display-side microcomputer 240. Display device 200 may also have other electrical structures and descriptions thereof are omitted.

Receiver 230 receives a signal transmitted from digital pen 300. Receiver 230 transmits the received signal to display-side microcomputer 240.

Display-side microcomputer 240 includes a CPU (Central Processing Unit) and a memory. Programs for operating the CPU are implemented in display-side microcomputer 240. Display-side microcomputer 240 controls contents on display panel 210 based on the signal transmitted from digital pen 300 to receiver 230 via wireless communication.

A configuration of display panel 210 is then described in detail. As shown in FIG. 3, display panel 210 includes optical film 211, touch sensor glass 218, and liquid crystal panel 219.

Optical film 211 includes, in order from top to bottom, PET (Poly Ethylene Terephthalate) film 213 as a substrate, a dot pattern formed of a plurality of dots 212, dot planarization layer 214, first bezel decorative layer 215, second bezel decorative layer 216, and decorative planarization layer 217.

PET film 213 protects a surface of display panel 210 and serves as a substrate for laminating a layer such as dots 212 or the like.

The plurality of dots 212 are applied on a back surface of PET film 213, i.e., on a lower side of FIG. 3. Each of the plurality of dots 212 projects from the back surface of PET film 213 by a thickness of dot 212. A plurality of dots 212 in a unit area of PET film 213 form a single dot pattern. Dot 212 is formed of a material that absorbs infrared light, i.e., a material having low transmittance for infrared light.

Dot planarization layer 214 is laminated on the back surface of PET film 213 so as to fill a space between dot 212 and dot 212. In other words, dot planarization layer 214 is formed to cover the back surface of PET film 213 and the plurality of dots 212. Dot planarization layer 214 is formed over the entire back surface of PET film 213. A back surface of dot planarization layer 214 is flat. Dot planarization layer 214 is made of a material that transmits both visible light and infrared light. Dot planarization layer 214 is made of, for example, an acrylic resin.

First bezel decorative layer 215 is laminated on a back surface of a peripheral portion of dot planarization layer 214 in bezel portion 210b, that is, on the lower side of FIG. 3. First bezel decorative layer 215 is made of a material that absorbs a specific visible wavelength and transmits infrared wavelengths of incident light. The material for first bezel decorative layer 215 is described later in detail.

Second bezel decorative layer 216 is laminated on a back surface of first bezel decorative layer 215, i.e., on the lower side of FIG. 3. Second bezel decorative layer 216 is made of a material that reflects infrared wavelengths of light passing through first bezel decorative layer 215. The material for second bezel decorative layer 216 is described later in detail.

Decorative planarization layer 217 is laminated to fill steps of the back surface of dot planarization layer 214 that are formed by first bezel decorative layer 215 and second bezel decorative layer 216. Decorative planarization layer 217 is formed over the entire back surface of dot planarization layer 214. A back surface of decorative planarization layer 217 is flat. Decorative planarization layer 217 is made of a material that transmits both visible light and infrared light. Decorative planarization layer 217 is made of, for example, an acrylic resin.

Touch sensor glass 218 is a glass with a sensor for detecting pressure when a user performs a touch operation. Touch sensor glass 218 is disposed on the back surface of decorative planarization layer 217, i.e., on the lower side of FIG. 3.

Liquid crystal panel 219 includes a color filter and a liquid crystal layer. A back surface of liquid crystal panel 219 is provided with a backlight device (not shown) for emitting light to liquid crystal panel 219. Liquid crystal panel 219 applies a voltage for changing liquid crystal alignment of the liquid crystal layer under the display control of display-side microcomputer 240. Thus, liquid crystal panel 219 controls an amount of transmission of light from the backlight device to perform various display operations.

A configuration of digital pen 300 is then described.

Digital pen 300 has an appearance similar to a writing utensil. Referring to FIG. 2, digital pen 300 is provided with cylindrical body case 310 and pen tip 320 attached to an end of body case 310. Digital pen 300 includes, within body case 310, pressure sensor 330, objective lens 340, image sensor 350, pen-side microcomputer 360, transmitter 370, and emitting element 380.

Body case 310 has a cylindrical shape. Pen tip 320 is tapered. An end of pen tip 320 is rounded to the extent that the surface of display panel 210 is not damaged. Pen tip 320 may be shaped so that a user can easily apply pressure to digital pen 300 while viewing an image displayed on display panel 210.

Body case 310 has built-in pressure sensor 330, which is coupled to a proximal end of pen tip 320. Pressure sensor 330 detects pressure applied to pen tip 320. Specifically, pressure sensor 330 detects pressure applied to pen tip 320 from display panel 210 when the user writes characters etc. on display panel 210 using digital pen 300. Pressure sensor 330 is used, for example, to determine whether the user has provided an input using digital pen 300. The pressure detected by pressure sensor 330 is indicated to pen-side microcomputer 360.

Emitting element 380 is provided in the vicinity of pen tip 320 of body case 310. Emitting element 380 is composed of, for example, an infrared LED (Light Emitting Diode). Emitting element 380 is configured to emit infrared light from pen tip 320 side of body case 310.

Objective lens 340 images light incident from pen tip 320 side on image sensor 350. Objective lens 340 is disposed in the vicinity of pen tip 320 of body case 310. When the infrared light is emitted from emitting element 380 with pen tip 320 of digital pen 300 directed towards display portion 210a or bezel portion 210b of display device 200, the infrared light passes through display panel 210 and is diffusely reflected in liquid crystal panel 219 located on the back side of display panel 210 or in second bezel decorative layer 216. As a result, part of the infrared light transmitted through display panel 210 returns to digital pen 300. The infrared light that has been emitted from emitting element 380 and diffusely reflected in display device 200 is incident on objective lens 340. Image sensor 350 is disposed on the optical axis of objective lens 340. The infrared light transmitted through objective lens 340 is therefore imaged on an imaging plane of image sensor 350.

Image sensor 350 outputs an image signal, which is obtained by converting an optical image that has been imaged on the imaging plane to an electrical signal, to pen-side microcomputer 360. Image sensor 350 is composed of, for example, a CCD (Charge Coupled Device) image sensor or a CMOS (Complementary Metal Oxide Semiconductor) image sensor. Dots 212 forming the dot pattern is formed of a material that absorbs infrared light, i.e., a material having low transmittance for infrared light. As such, little infrared light returns to digital pen 300 from dots 212 forming the dot pattern. On the other hand, more infrared light returns from a region between dots 212 as compared with from a region of dot 212. Consequently, image sensor 350 captures an optical image in which the dot pattern is represented as black.

Pen-side microcomputer 360 identifies position information of digital pen 300 on display panel 210 by using the image signal captured and generated by image sensor 350. Specifically, pen-side microcomputer 360 obtains a pattern shape of the dot pattern from the image signal captured and generated by image sensor 350 and identifies a position of pen tip 320 on display panel 210 by using the pattern shape. Pen-side microcomputer 360 includes a CPU and a memory, and programs for operating the CPU are implemented in the memory.

Transmitter 370 sends out a signal to an external device. Specifically, transmitter 370 sends the position information identified by pen-side microcomputer 360 to receiver 230 of display device 200 as a wireless communication recipient.

### [2. Dot Pattern]

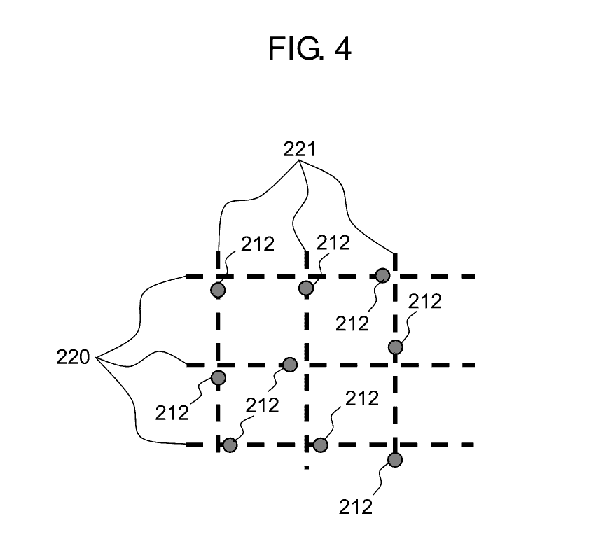

Details of the dot pattern will now be described. FIG. 4 is an enlarged view of a dot pattern according to the first exemplary embodiment, where the dot pattern is viewed from PET film 213 side of optical film 211. In FIG. 4, first reference lines 220 and second reference lines 221, which are virtual lines that do not actually exist on optical film 211, are drawn on optical film 211 in order to show positions of dots 212 of the dot pattern. First reference lines 220 and second reference lines 221 are perpendicular to one another, and first reference lines 220 and second reference lines 221 form a grid.

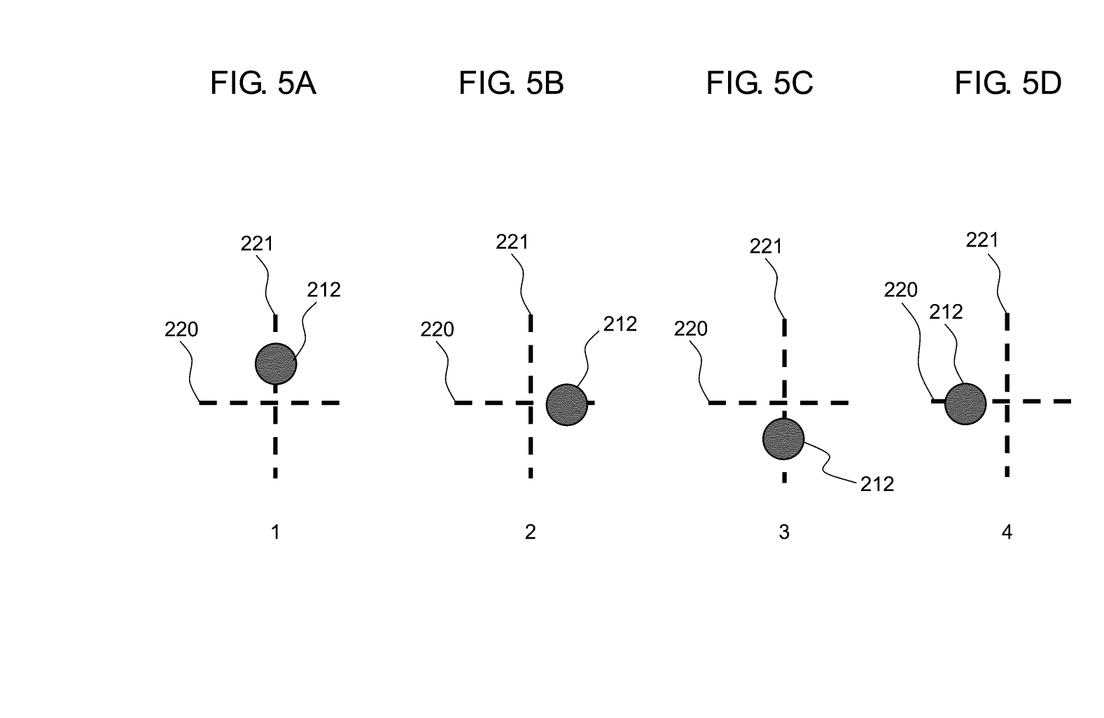

Each of dots 212 is positioned near an intersection of first reference line 220 and second reference line 221. That is, dot 212 is positioned in the vicinity of a grid point. FIG. 5A is a first diagram illustrating a positioning pattern of a dot 212. FIG. 5B is a second diagram illustrating a positioning pattern of a dot 212. FIG. 5C is a third diagram illustrating a positioning pattern of a dot 212. FIG. 5D is a fourth diagram illustrating a positioning pattern of a dot 212. In FIGS. 5A to 5D, dot 212 is positioned at a position offset toward a positive or negative side in an X or Y direction from the intersection of first reference line 220 and second reference line 221, where the X direction is a direction in which first reference line 220 extends and the Y direction is a direction in which second reference line 221 extends. Specifically, each dot 212 in optical film 211 is positioned at any one of positions shown in FIGS. 5A to 5D. In FIG. 5A, dot 212 is positioned upwardly of the intersection of first reference line 220 and second reference line 221. This position is quantified and represented by “1”. In FIG. 5B, dot 212 is positioned to the right of the intersection of first reference line 220 and second reference line 221. This position is quantified and represented by “2”. In FIG. 5C, dot 212 is positioned downwardly of the intersection of first reference line 220 and second reference line 221. This position is quantified and represented by “3”. In FIG. 5D, dot 212 is positioned to the left of the intersection of first reference line 220 and second reference line 221. This position is quantified and represented by “4”. As described above, dot 212 is represented by a value of “1”, “2”, “3”, or “4” based on its positioning pattern.

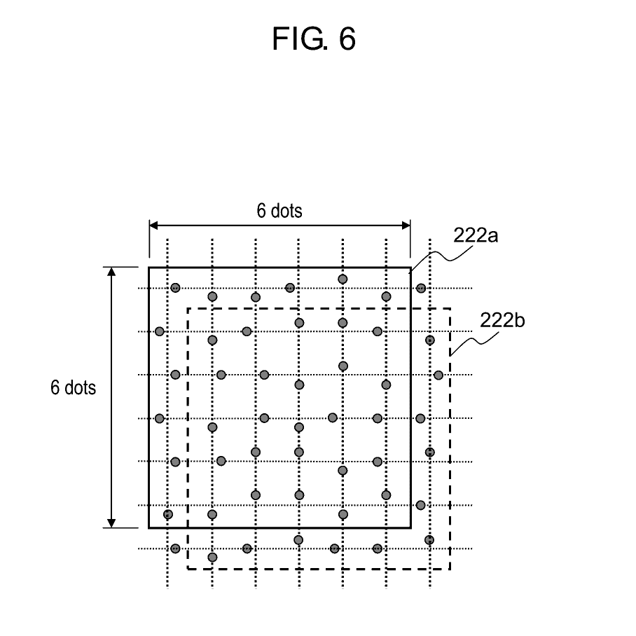

FIG. 6 is a diagram illustrating a dot pattern and a unit area. In FIG. 6, a dot 212 arrangement of 6 dots vertically by 6 dots horizontally forms each of unit areas 222a and 222b, and 36 dots 212 contained in the unit area constitute a dot pattern. Each of respective 36 dots 212 contained in unit areas 222a and 222b is disposed at any one of the positions from value “1” to value “4” illustrated in FIGS. 5A to 5D so that dot patterns having different information to each other can be formed. The dot patterns of unit areas 222a and 222b on optical film 211 are different from each other. Thus, the dot patterns of all unit areas are configured to be different from one another.

The dot pattern of the unit area of optical film 211 indicates position coordinates. In FIG. 6, the dot pattern of unit area 222a indicates position coordinates of a center position of unit area 222a, and the dot pattern of unit area 222b indicates position coordinates of a center position of unit area 222b. When pen tip 320 moves diagonally to the lower right in FIG. 6, the unit area read by digital pen 300 shifts from unit area 222a to unit area 222b. A change in the position coordinates is calculated from a shift of the unit area.

### [3. Display Operation]

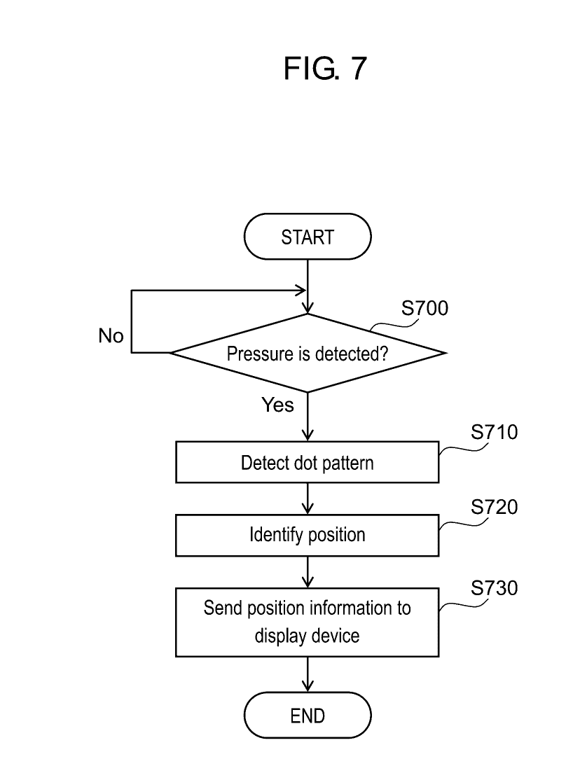

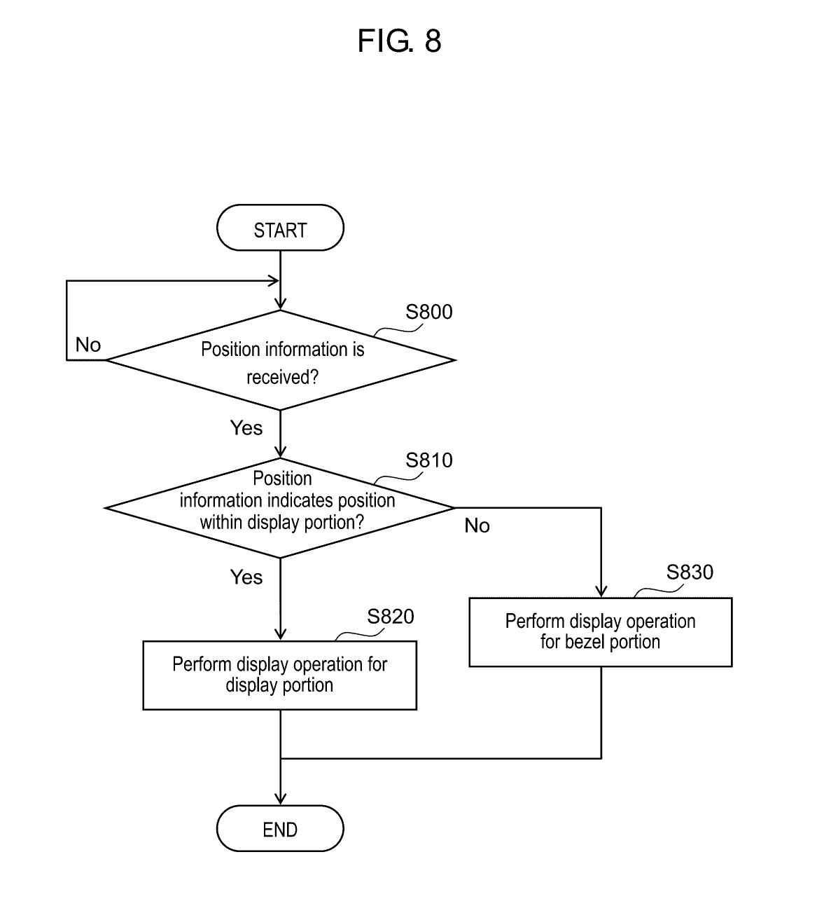

A display operation of display control system 100 will now be described with reference to FIGS. 7 and 8. FIG. 7 is a flow chart illustrating an operation of digital pen 300 according to the present exemplary embodiment, and FIG. 8 is a flow chart illustrating an operation of display device 200 according to the present exemplary embodiment. A case where a user inputs a character in display device 200 using digital pen 300 is then described.

Display device 200 and digital pen 300 constituting display control system 100 are first turned on. This allows power to be supplied from a power supply (not shown) to display-side microcomputer 240, which completes an initial operation for executing various operations. Similarly, power is supplied from a power supply (not shown) to pen-side microcomputer 360, which completes an initial operation for executing various operations. Display device 200 and digital pen 300 establish wireless communication with each other using a pairing technique for wireless communication. This enables communication from transmitter 370 of digital pen 300 to receiver 230 of display device 200.

The operation of digital pen 300 is then described with reference to FIG. 7.

(S700) Pen-side microcomputer 360 of digital pen 300 detects pressure at pen tip 320. The pressure is detected by pressure sensor 330. If the pressure is detected by pressure sensor 330 (i.e., if Yes), a process proceeds to step S710. If the pressure is not detected by pressure sensor 330 (i.e., if No), the process returns to step S700.

(S710) Pen-side microcomputer 360 determines that a user is entering a character or the like on display panel 210 of display device 200 with digital pen and causes emitting element 380 to emit infrared light.

Objective lens 340 and image sensor 350 detect a dot pattern at a position where pen tip 320 is located. Here, the infrared light emitted from emitting element 380 is diffusely reflected in liquid crystal panel 219 or second bezel decorative layer 216, and part of the infrared light returns to digital pen 300.

When pen tip 320 of digital pen 300 is located on display portion 210a of display panel 210, there exist PET film 213, dot planarization layer 214, decorative planarization layer 217, touch sensor glass 218, and liquid crystal panel 219 in an emission direction of the infrared light. PET film 213, dot planarization layer 214, decorative planarization layer 217, and touch sensor glass 218 are made of a material that transmits infrared light so that they can transmit most of the infrared light. On the other hand, the emitted infrared light is diffusely reflected on liquid crystal panel 219 due to a diffuse reflective sheet attached to the surface of liquid crystal panel 219. Thus, part of the infrared light emitted from digital pen 300 to display portion 210a returns to digital pen 300.

When pen tip 320 of digital pen 300 is located on bezel portion 210b of display panel 210, there exist PET film 213, dot planarization layer 214, first bezel decorative layer 215, and second bezel decorative layer 216 in an emission direction of the infrared light. PET film 213, dot planarization layer 214, and first bezel decorative layer 215 are made of a material that transmits infrared light so that they can transmit most of the infrared light. On the other hand, second bezel decorative layer 216 diffusely reflects the infrared light. Thus, part of the infrared light emitted from digital pen 300 to bezel portion 210b returns to digital pen 300.

The infrared light returning to digital pen 300 in display portion 210a and bezel portion 210b hardly passes through dots 212 of the dot pattern. The infrared light transmitted through the region between dots 212 largely reaches objective lens 340. The infrared light is received by image sensor 350 through objective lens 340. Objective lens 340 is disposed so as to receive reflected light from a position at which pen tip 320 is located on display panel 210. As a result, image sensor 350 images a dot pattern at the position where pen tip 320 is located on a screen of display panel 210. Thus, objective lens 340 and image sensor 350 optically read the dot pattern. An image signal captured and generated by image sensor 350 is transmitted to pen-side microcomputer 360.

(S720) Pen-side microcomputer 360 obtains a pattern shape of the dot pattern from the image signal received and identifies the position of pen tip 320 on display panel 210 by using the pattern shape.

(S730) Pen-side microcomputer 360 sends the identified position to display device 200 through transmitter 370. In this manner, display device 200 can determine the position of pen tip 320 of digital pen 300.

Subsequently, the operation of display device 200 is described with reference to FIG. 8.

Position information transmitted from digital pen 300 is received by receiver 230 of display device 200. The received position information is transmitted from receiver 230 to display-side microcomputer 240.

(S800) Display-side microcomputer 240 detects whether the position information is received. If the position information is not received (i.e., if No), a process returns to step S800. If the position information is received (i.e., if Yes), the process proceeds to step S810.

(S810) It is determined whether the received position information indicates a position within display portion 210a or a position within bezel portion 210b. If the received position information indicates the position within display portion 210a (i.e., if Yes), the process proceeds to step S820. If the received position information indicates the position within bezel portion 210b (i.e., if No), the process proceeds to step S830.

(S820) Display-side microcomputer 240 causes display panel 210 to perform a display operation for display portion 210a. Specifically, display-side microcomputer 240 controls display panel 210 to change indicia displayed at a position corresponding to the position information in a display area of display panel 210. Since a character is input in the present exemplary embodiment, a dot is displayed at a position corresponding to the position information in the display area of display panel 210. When input with digital pen 300 is continued, display-side microcomputer 240 continuously obtains position information. Thus, the dot can be sequentially displayed at the position of pen tip 320 on the display area of display panel 210 while following the movement of pen tip 320 of digital pen 300. That is, a character corresponding to the locus of pen tip 320 of digital pen 300 can be displayed on display panel 210.

(S830) Display-side microcomputer 240 causes display panel 210 to perform a display operation for bezel portion 210b. Specifically, display-side microcomputer 240 recognizes that the obtained position information indicates bezel portion 210b and controls display panel 210 to perform operations such as displaying menus and switching views on the basis of specifications of an operating system. The menu is displayed on display portion 210a of display panel 210.

If pressure sensor 330 does not detect pressure for a predetermined time or more in step S800, pen-side microcomputer 360 determines that pen input by the user is not continued and ends the process. Pen-side microcomputer 360 then stops sending the position information to display-side microcomputer 240. In this manner, display-side microcomputer 240 can determine that the pen input is not continued, and display-side microcomputer 240 ends the process as well.

While a character is written on display portion 210a in the above description, use of display control system 100 is not limited thereto. Of course, symbols, drawings, and the like as well as characters and numerals can be written. In addition, characters, drawings, etc. displayed on display panel 210 can also be erased using digital pen 300 as an eraser. Furthermore, by using digital pen 300 as a mouse, a cursor displayed on display panel 210 can be moved and an icon displayed on display panel 210 can be selected. That is, use of digital pen 300 allows GUI (Graphical User Interface) operations.

In display control system 100, as described above, display device 200 accepts input based on the position on display panel 210 indicated by digital pen 300 and display device 200 can perform various types of display control in response to the input.

### [4. Material of Bezel Portion]

Materials of first bezel decorative layer 215 and second bezel decorative layer 216 will now be described.

For first bezel decorative layer 215, a material is selected that absorbs suitable visible light in order to transmit infrared light and obtain a desired bezel color in accordance with design. Printing pigment and dye pigment may be used for first bezel decorative layer 215. Pigment dye that transmits the infrared light includes fuchsin, rosaniline, chrome yellow, cyanine, phthalocyanine blue, rhodamine lake, benzine yellow, cyanine blue, and the like. Mixture of dyes that transmit the infrared light can make many bezel color variations. On the other hand, a dye containing a large amount of carbon black, which absorbs infrared light, absorbs the infrared light emitted from digital pen 300 and the infrared light is not incident on objective lens 340 and image sensor 350 of digital pen 300 so that such a dye is not suitable for use.

Second bezel decorative layer 216 has suitable reflective properties of visible light and reflective properties of infrared light so as to obtain a desired color in conjunction with spectral transmission properties of first bezel decorative layer 215. Assuming a bezel color is determined by selection of a material used for first bezel decorative layer 215, it is desirable to select a material having a high reflectance from visible light to infrared light as a material of second bezel decorative layer 216. Examples of the material of second bezel decorative layer 216 include titanium oxide and titanium dioxide. These materials have the property of diffusely reflecting light and can reflect part of the infrared light emitted from the digital pen in the direction of an optical system of the digital pen.

While the bezel color is achieved only by selecting the material of first bezel decorative layer 215 in the above description, the bezel color may be achieved by other means. A combination of a material used for first bezel decorative layer 215 and a material used for second bezel decorative layer 216 may achieve the bezel color by adjusting visible light reflectance of the material used for second bezel decorative layer 216. Furthermore, in order to obtain diffuse reflection of the infrared light, it may be configured such that first bezel decorative layer 215 is provided with transmission diffusivity and specularity of second bezel decorative layer 216 is used.

### [5. Advantageous Effect]

As described above, it is possible to increase the color variations in the bezel portion while maintaining accuracy of reading a position information pattern of the bezel portion using the digital pen as a reader.

In the foregoing specification, the first exemplary embodiment has been described as an example of the present disclosure. The technique according to the present disclosure, however, is not limited thereto and is applicable to exemplary embodiments in which modifications, substitutions, additions, and omissions are made if needed.

For example, the dot pattern is illustrated as a position information pattern in the above description, but the position information pattern is not limited thereto. The position information pattern may be formed by arranging predetermined marks regularly, without using any dots.

In addition, while placement of first bezel decorative layer 215 and second bezel decorative layer 216 such as shown in FIG. 3 has been described in the above description, the placement thereof is not limited thereto.

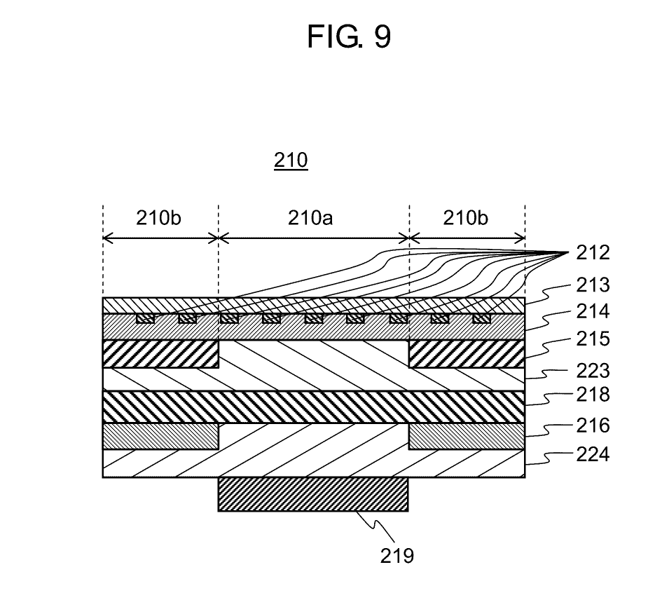

FIG. 9 is another cross-sectional view taken along 3-3 of the display panel of FIG. 1. For example, and as shown in FIG. 9, first decorative planarization layer 223 planarized with first bezel decorative layer 215 and second decorative planarization layer 224 planarized with second bezel decorative layer 216 may be disposed on either side of touch sensor glass 218 sandwiched between first bezel decorative layer 215 and second bezel decorative layer 216.

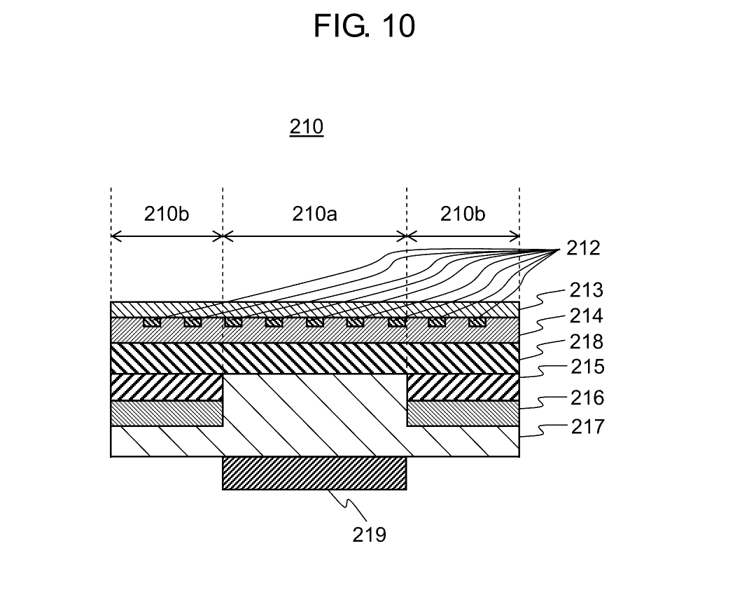

FIG. 10 is still another cross-sectional view taken along 3-3 of the display panel of FIG. 1. As shown in FIG. 10, touch sensor glass 218 may be disposed on the back surface of dot planarization layer 214, i.e., on the lower side of FIG. 10, and first bezel decorative layer 215, second bezel decorative layer 216, and decorative planarization layer 217 planarizing first bezel decorative layer 215, second bezel decorative layer 216 may be disposed on the back surface of touch sensor glass 218, i.e., on the lower side of FIG. 10. In short, first bezel decorative layer 215 that absorbs specific visible light and transmits infrared light only needs to be disposed on the back surface of bezel portion 210b and second bezel decorative layer 216 that reflects the infrared light only needs to be disposed on the back surface side of first bezel decorative layer 215.

The present disclosure is applicable to an optical film, a display panel, a display device, and the like.

What is claimed is:

1. An optical film comprising:
a display portion; and
a bezel portion formed around the display portion,
wherein
the display portion and the bezel portion each are provided with a pattern representing position information of each of a plurality of unit areas, and
a back side of the bezel portion is provided with a first bezel decorative layer that absorbs a specific visible wavelength and transmits infrared wavelengths of incident light, and a second bezel decorative layer that reflects infrared wavelengths passing through the first bezel decorative layer.

2. The optical film according to claim 1,
wherein the pattern comprises a plurality of dots or predetermined marks, each of the plurality of dots or predetermined marks is positioned in relative to a grid point of a virtual reference grid and represents the position information.

3. The optical film according to claim 1, further comprising a planarization layer for covering the pattern,
wherein the pattern is formed of a material having low transmittance for infrared light as compared to a material of the planarization layer.

4. A display panel comprising:
a panel for displaying an image; and
the optical film of claim 1 that is provided on the panel.

5. A display device comprising:
the display panel of claim 4;
a receiver for receiving position information of the pattern detected by a reader, the pattern being provided on a back side of the display portion; and
a display controller for controlling what is displayed on the display panel, based on the position information received by the receiver.
